(19) United States
(12) Patent Application Publication
(10) Pub. No.: US 2017/0061284 A1
(43) Pub. Date: Mar. 2, 2017

(54) OPTIMIZATION OF PREDICTOR VARIABLES

(71) Applicant: INTERNATIONAL BUSINESS MACHINES CORPORATION, Armonk, NY (US)

(72) Inventors: SHUNICHI AMANO, TOKYO (JP); KOHICHI KAMIJOH, TOKYO (JP); RYO KAWAHARA, TOKYO (JP); MASAKI M. ONO, TOKYO (JP); TAKAYUKI OSOGAMI, TOKYO (JP)

(21) Appl. No.: 14/841,562

(22) Filed: Aug. 31, 2015

(51) Int. Cl. G06N 3/12; G06N 99/00

(52) U.S. Cl. CPC G06N 3/126; G06N 99/005

(57) ABSTRACT

A method and apparatus for optimization of predictor variables. The apparatus includes a value obtaining section to obtain a plurality of answers from an answer database, each answer including an answered value for each variable of a plurality of variables, the plurality of variables answered by each respondent of a plurality of respondents, a cost obtaining section to obtain a cost for answering each of the plurality of variables from a cost database, and a determining section to determine at least one predictor variable from the plurality of variables based on a prediction performance and an answering cost, the at least one predictor variable for predicting at least one remaining variable of the plurality of variables.

### BACKGROUND

Technical Field

The present invention relates to an apparatus for optimizing predictor variables of a set of variables.

Related Art

Financial advice services have been given to customers by financial advisers. In these services, financial simulations for household accounts, household assets, insurance, etc., have been provided. Since the simulation needs a large number of parameters, customers are required to provide answers to a large number of questions (e.g., age, sexuality, marital status, number of children, etc.) in an answer sheet. Sometimes, it is difficult for the customers to answer some questions due to a psychological hurdle and/or a lack of knowledge. Advisers (e.g., financial planners) may help customers fill in the answer sheet. However, in the absence of the advisers, some customers may give up answering difficult questions or may provide inaccurate answers in the answer sheet.

Methods for inputting values for a portion of variables (e.g., answers to a portion of questions), and predicting values of other variables (e.g., answers to the other questions), such as principal component analysis (PCA) and compressed sensing (CS), are known. However, the opportunity cost of inputting values (e.g., difficulty in answering questions) has not been considered in the known methods. In addition, even if a system only provides customers with only easy-to-answer questions, and predicts answers to other questions, the accuracy of the prediction of the answers may not be sufficient to rely on the simulation.

A method for inputting preliminary default answers in an answer sheet to assist a user's input may be known. However, these default answers are usually not applicable to most users. Therefore, this method requires many modifications by the user.

Systems, such as the system disclosed in U.S. Patent Publication No. 2009/0204881, is comprised of entities, interactions and users, and enables automatic form-filling for forms comprised of one or more fields that are used in various domains, and verification of these forms. This is performed by encapsulating the knowledge required to fill forms into three hierarchical components, namely (a) form knowledge, (b) process knowledge, and (c) domain knowledge. However, since the system does not consider any costs of answering questions, the respondents may still find it difficult to fill in an answer sheet, which may impair the accuracy of the answers.

### SUMMARY

According to the present principles, an apparatus for optimization of predictor variables is provided. The apparatus may include a value obtaining section to obtain a plurality of answers from an answer database, each answer including an answered value for each variable of a plurality of variables, the plurality of variables answered by each respondent of a plurality of respondents, a cost obtaining section to obtain a cost for answering each of the plurality of variables from a cost database, and a determining section to determine at least one predictor variable from the plurality of variables based on a prediction performance and an answering cost, the at least one predictor variable for predicting at least one remaining variable of the plurality of variables. In an embodiment, the apparatus may enable the determination of predictor variable(s) used in a prediction model that has both a great prediction performance and lower cost, thereby providing respondents with an inquiry of minimal difficulty without sacrificing prediction performance.

In an embodiment, the determining section may include a generating section to generate a prediction model for predicting a value of at least one remaining variable candidate based on a given value of at least one predictor variable candidate, an evaluating section to evaluate the at least one predictor variable candidate using an objective function, the objective function being a function of the prediction performance and the answering cost, the prediction performance being derived from the prediction model, and a selecting section to select at least one predictor variable based on a result of evaluation of the evaluating section. The present principles may enable the determination of a set of predictor variables based on the comparison of evaluations of all predictor variable candidates.

In an embodiment, the prediction performance includes a prediction accuracy, a Gini index, or an entropy gain of the prediction model. The present principles may enable the generation of a high quality prediction model.

In an embodiment, the objective function may be a function of an average prediction accuracy of the value of the at least one remaining variable candidate and the answering cost. The present principles may enable the generation of an accurate prediction model.

In an embodiment, the apparatus may further include a receiving section to receive an input value of the at least one predictor variable input in an answer sheet, and a predicting section to predict a value of the at least one remaining variable by using the prediction model for predicting the value of the at least one remaining variable based on the input value of the at least one predictor variable. The present principles may enable the prediction of values of remaining variables based on the prediction model and input values of the predictor variables.

In an embodiment, the apparatus may further include a filling section to fill in the value of the at least one remaining variable predicted by the predicting section in the answer sheet. The present principles may provide complement answers of unanswered questions in the answer sheet.

In an embodiment, the receiving section may be further configured to receive an input value of the at least one remaining variable, and update the at least one remaining variable with the input value of the at least one remaining variable received by the receiving section. The present principles may enable the respondent to modify answers to the questions when the predicted answers are wrong.

In an embodiment, the generating section may be further configured to generate a prediction model for each of the plurality of variables that has not been determined as the at least one predictor variable. The evaluating section may be further configured to evaluate each of the plurality of variables that has not been determined as the at least one predictor variable. The selecting section may be further configured to select one of the plurality of variables that has not been determined as the at least one predictor variable and that improves the objective function the most to include in the at least one predictor variable. The present principles may enable the addition of a predictor variable based on the comparison of evaluations of all predictor variable candidates.

In an embodiment, the apparatus may further include a splitting section to split a domain of the one of the plurality of variables selected by the selecting section. The generating section, the evaluating section, the selecting section, and the splitting section may hierarchically select the at least one predictor variable to generate a decision tree of the at least one predictor variable. The present principles may enable the determination of one predictor variable based on the comparison of evaluations of all predictor variable candidates with a decision tree.

In an embodiment, the selecting section may be further configured to stop selecting predictor variables if the objective function does not improve during evaluation by the evaluating section. The present principles may stop the search for additional predictor variables in response to the improvement of the prediction model being no longer expected.

In an embodiment, each cost may be a length of time taken by one of the plurality of respondents to answer one of the plurality of variables. The present principles may enable the measurement of a cost of the predictor variables in the prediction model.

In an embodiment, the cost obtaining section may be configured to obtain the cost for answering each of the plurality of variables by using a response rate of the answered value for each of the plurality of variables. The present principles may enable the measurement of a cost of the predictor variables in the prediction model.

In an embodiment, the prediction accuracy may be based on comparing a value of the at least one remaining variable predicted by the predicting section with at least one of the answered values corresponding to the remaining variable in the answer database. The present principles may enable the measurement of an accuracy of the predictor variables in the prediction model.

According to the present principles, a computer-implemented method for optimization of predictor variables may be provided. The computer-implemented method may include obtaining a plurality of answers from an answer database, each answer including an answered value for each variable of a plurality of variables, the plurality of variables answered by each respondent of a plurality of respondents, obtaining a cost for answering each of the plurality of variables from a cost database, and determining at least one predictor variable from the plurality of variables based on a prediction performance and an answering cost, the at least one predictor variable for predicting at least one remaining variable of the plurality of variables. The fourteenth aspect may enable the determination of predictor variable(s) used in a prediction model that has both a high prediction performance and lower cost, thereby providing respondents with an inquiry of minimal difficulty without sacrificing prediction performance.

According to the present principles, a computer program product for optimization of predictor variables may be provided. The computer program product may include a non-transitory computer readable storage medium having program instructions embodied therewith, the program instructions executable by a computer to cause the computer to perform a method, wherein the method may include obtaining a plurality of answers from an answer database, each answer including an answered value for each variable of a plurality of variables, the plurality of variables answered by each respondent of a plurality of respondents, obtaining a cost for answering each of the plurality of variables from a cost database, and determining at least one predictor variable from the plurality of variables based on a prediction performance and an answering cost, the at least one predictor variable for predicting at least one remaining variable of the plurality of variables. The fifteenth aspect may enable the determination of predictor variable(s) used in a prediction model that has both a great prediction performance and lower cost, thereby providing respondents with an inquiry of minimal difficulty without sacrificing prediction performance.

The summary clause does not necessarily describe all of the features of the embodiments of the present invention. The present invention may also be a sub-combination of the features described above. The above and other features and advantages of the present principles will become more apparent from the following description of the embodiments, taken in conjunction with the accompanying drawings.

### BRIEF DESCRIPTION OF THE DRAWINGS

FIG. 1 shows an exemplary configuration of an apparatus for optimization of predictor variables, according to an embodiment;

FIG. 2 shows answers in an answer database, according to an embodiment;

FIG. 3 shows input values in an answer sheet, according to an embodiment;

FIG. 4 shows predicted values, according to an embodiment;

FIG. 5A shows an operational flow of an exemplary configuration of an apparatus in a modeling phase, according to an embodiment;

FIG. 5B shows an operational flow of an exemplary configuration of an apparatus in a prediction phase, according to an embodiment;

FIG. 6 shows an example of a greedy algorithm, according to an embodiment;

FIG. 7 shows an operational flow of a determination of predictor variables, according to an embodiment;

FIG. 8 shows an exemplary configuration of the apparatus, according to an embodiment;

FIG. 9 shows an example of a decision tree learning algorithm with recursive optimization of variable selection, according to an embodiment;

FIG. 10A shows an operational flow of an exemplary configuration of an apparatus in a modeling phase, according to an embodiment;

FIG. 10B shows an operational flow of an exemplary configuration of an apparatus in a prediction phase, according to an embodiment;

FIG. 11 shows an operational flow of a determination of predictor variables, according to an embodiment; and

FIG. 12 shows an overall functional block diagram of a computer system hardware for optimization of predictor variables, according to an embodiment of the present invention.

### DETAILED DESCRIPTION OF THE EMBODIMENTS

The descriptions of the various embodiments, including example embodiments, of the present invention will be described. The embodiments described herein are not intended to limit the claims, and not all of the combinations of the features described in the embodiments are necessarily essential to the invention.

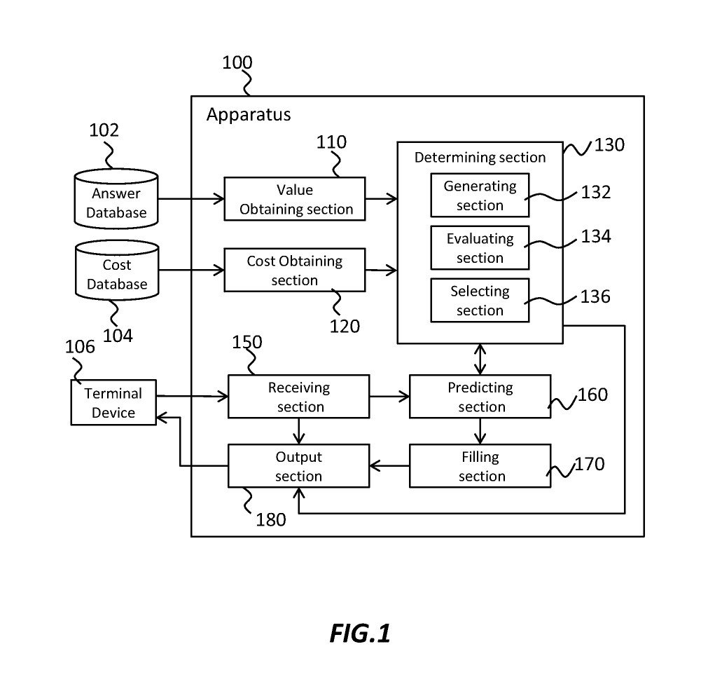

With reference now to FIG. 1, FIG. 1 shows a block diagram of an apparatus 100 according to one embodiment of the present principles. The apparatus 100 may determine at least one predictor variable from a plurality of variables, based on a prediction performance and a cost of obtaining the predictor variables. The at least one predictor variable is used to predict at least one remaining variable of the plurality of variables.

The plurality of variables may correspond to answers to a plurality of questions, and the predictor variables may correspond to answers that are manually provided by respondents (e.g., customers of financial services). The remaining variables may correspond to answers that are not provided by respondents, but predicted by the respondent-provided answers. However, other implementations may also be possible. The apparatus 100 may include a value obtaining section 110, a cost obtaining section 120, a determining section 130, a receiving section 150, a predicting section 160, a filling section 170, and an output section 180.

The value obtaining section 110 is connected to an answer database 102 and the determining section 130, and obtains a plurality of answers to questions from the answer database 102. Each answer includes an answered value for each variable of a plurality of variables. Values of the plurality of variables in each answer may correspond to answers to all or a portion of the questions answered by each respondent of a plurality of respondents. The value obtaining section 110 may provide the determining section 130 with the obtained plurality of answers as testing data. The answer database 102 may be implemented within the apparatus 100. The answer database 102 may be a computer readable storage medium, such as an electric storage device, a magnetic storage device, an optical storage device, an electromagnetic storage device, a semiconductor storage device, etc.

The cost obtaining section 120 is connected to a cost database 104, and obtains a cost for answering a question corresponding to each of the plurality of variables from the cost database 104. The cost obtaining section 120 may obtain the cost of each of the answers obtained by the value obtaining section 110. The cost may represent an amount of difficulty with which a respondent gives an answer to a question. The cost obtaining section 120 may provide the determining section 130 with the obtained cost. The cost database 104 may be implemented within the apparatus 100. The cost database 104 may be a computer readable storage medium such as an electric storage device, a magnetic storage device, an optical storage device, an electromagnetic storage device, a semiconductor storage device, etc.

The determining section 130 is connected to the value obtaining section 110, the cost obtaining section 120, the predicting section 160, and the output section 180. The determining section 130 determines at least one predictor variable from the plurality of variables based on a prediction performance and an answering cost. The determining section 130 may include a generating section 132, an evaluating section 134, and a selecting section 136.

The generating section 132 generates a prediction model for predicting a value of at least one remaining variable candidate based on a given value of at least one predictor variable candidate. The generating section 132 may select each variable as a predictor variable candidate, and generate a prediction model as a prediction model candidate for each predictor variable candidate based on the answered values of the testing data.

The evaluating section 134 evaluates the at least one predictor variable candidate using an objective function of the prediction model generated by the generating section 132. The objective function may be a function that represents the prediction performance and the answering cost of the prediction model. The prediction performance may represent a quality of prediction by the prediction model, and may be a prediction accuracy, a Gini index, or an entropy gain of the prediction by the prediction model. The prediction accuracy may represent an accuracy with which the prediction model candidate predicts values of the remaining variables from values of the predictor variables, and may be derived from the prediction model. The evaluating section 134 may include the total cost of all of the predictor variables in the objective function.

The selecting section 136 selects the at least one predictor variable based on a result of evaluation of the evaluating section 134. The selecting section 136 may select one or more predictor variables such that the prediction performance and the costs of the answers are optimized based on the objective function. The selecting section 136 may provide the predicting section 160 with one prediction model candidate that includes the selected predictor variable(s) (which may be referred to as the “optimized prediction model”). The selecting section 136 may further provide the output section 180 with the optimized prediction model.

Each of the generating section 132, evaluating section 134, and the selecting section 136, may be a circuit, a shared or dedicated computer readable medium storing computer readable program instructions executable by a shared or dedicated processor, etc. The circuits, computer-readable mediums, and/or processors may be implemented in shared or dedicated servers.

The receiving section 150 is connected to a terminal device 106, the predicting section 160 and the output section 180, and receives input value(s) of the at least one predictor variable which is input in an answer sheet by a respondent via the terminal device 106. The receiving section 150 may receive the input value of the predictor variable(s) of the optimized prediction model. The receiving section 150 may provide the predicting section 160 with the input value(s).

The receiving section 150 may further receive an input value of the at least one remaining variable. Thereby, the receiving section 150 may receive a modification of the predicted answers. The receiving section 150 may further update the at least one remaining variable with the input value of the at least one remaining variable received by the receiving section. Thereby, the receiving section 150 may update the answer sheet with the more accurate answer input by the respondent. The receiving section 150 may provide the output section 180 with the updated input value(s).

The predicting section 160 is connected to the determining section 130, the receiving section 150, and the filling section 170, and predicts a value of the at least one remaining variable by using the prediction model for predicting the value of the at least one remaining variable. The predicting section 160 may receive value(s) of the predictor variable candidate(s) from the generating section 132, predict value(s) of the remaining variable candidates(s) by using the prediction model candidate based on the answered value of the predictor variable candidate(s), and provide the evaluating section 134 with the predicted value(s). The predicting section 160 may also receive at least one value of the input value(s) from the receiving section 150 as the predictor variable(s), predict value(s) of the remaining variable(s) by using the optimized prediction model based on the input value of the at least one predictor variable, and provide the filling section 170 with the predicted value(s).

The filling section 170 is connected to the predicting section 160 and the output section 180, and fills in the value(s) of the at least one remaining variable predicted by the predicting section 160 in the answer sheet. The filling section 170 may provide the output section 180 with the filled answer sheet.

The output section 180 is connected to the terminal device 106, the determining section 130, the receiving section 150, and the filling section 170. The output section 180 may output the result of the process of the apparatus 100 to the terminal device 106. The output section 180 may display the result of the process (e.g., the filled answer sheet) on a screen in communication with the apparatus 100, such as a screen of the terminal device 106. Terminal device 106 may be any device capable of receiving respondent input, and sending the input to the receiving section, such as a smartphone, a tablet computer, a desktop computer, etc.

Each of the value obtaining section 110, cost obtaining section 120, determining section 130, receiving section 150, predicting section 160, filling section 170, and output section 180, may be a circuit, a shared or dedicated computer readable medium storing computer readable program instructions executable by a shared or dedicated processor, etc. The circuits, computer-readable mediums, and/or processors may be implemented in shared or dedicated servers.

In some embodiments, the output section 180 may generate a form of an answer sheet including questions that correspond to the prediction variable(s) of the optimized prediction model, and output the form such that the respondent can enter values of the predictor variable of the optimized prediction model via the terminal device 106. In other embodiments, the output section 180 may output the filled answer sheet and/or the updated answer sheet that includes the updated input value(s). According to the present principles, by considering the cost for obtaining each variable, fewer answers to the questions in the answer sheet are needed from the customer, thereby increasing computational time and accuracy in predicting the remaining variables.

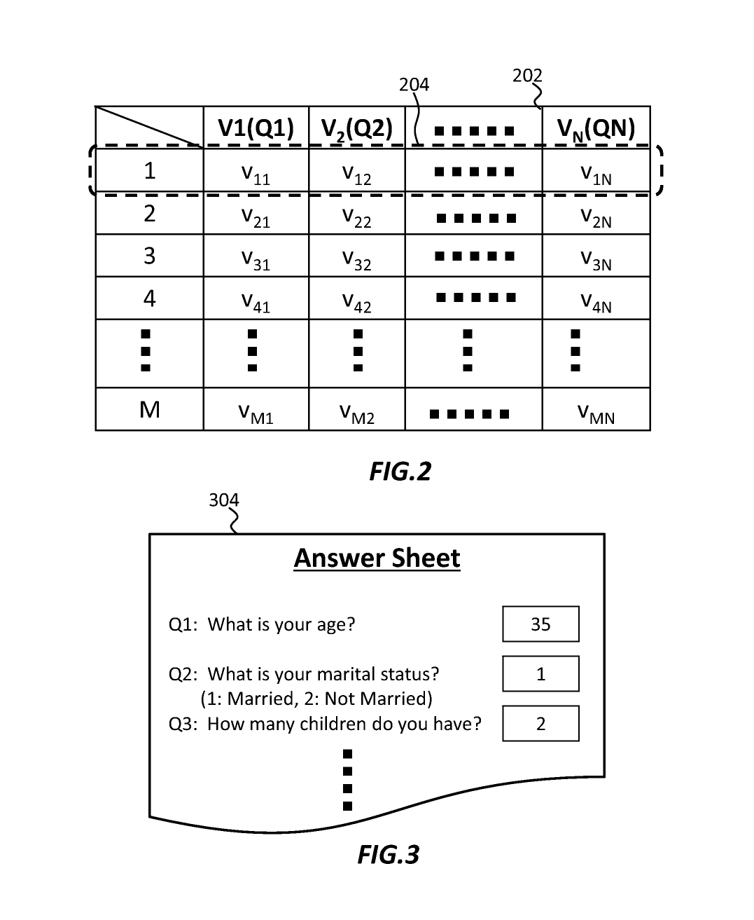

FIG. 2 shows answers in an answer database 202, according to an embodiment. A value obtaining section, such as value obtaining section 110, may obtain the answers stored in the answer database 202, as shown in FIG. 2. In this embodiment, the answers include answers of M respondents, which correspond to M rows in the table of FIG. 2. For example, an answer of a first respondent (m=1) is shown in a dashed square 204. Each answer sheet includes N values of N variables (V₁ . . . V_{N}) for every respondent (1 . . . M). Each value of N variables corresponds to an answer to N questions (Q1 . . . QN). For example, vii is a value of 1st variable V₁, which represents an answer to Question 1 (Q1) by the first respondent (m=1), and v_{MN} is a value of N^{th} variable V_{N}, which represents an answer to Question N (QN) by the M^{th} respondent.

FIG. 3 shows input values in an answer sheet 304, according to an embodiment. A receiving section, such as receiving section 150, may input values in the answer sheet as shown in FIG. 3. In some embodiments, respondents may be provided questions, and input values that represent the answers to the questions. In this embodiment, the receiving section may receive a value “35” for a variable V₁ as an answer to Q1, a value “1” for a variable V₂ as an answer to Q2, and a value “2” for a variable V₃ as an answer to Q3. The respondents may be provided a portion of the questions that correspond to predictor variables from among all of the variables. Questions that are not provided to the respondents (not shown in FIG. 3) correspond to remaining variables.

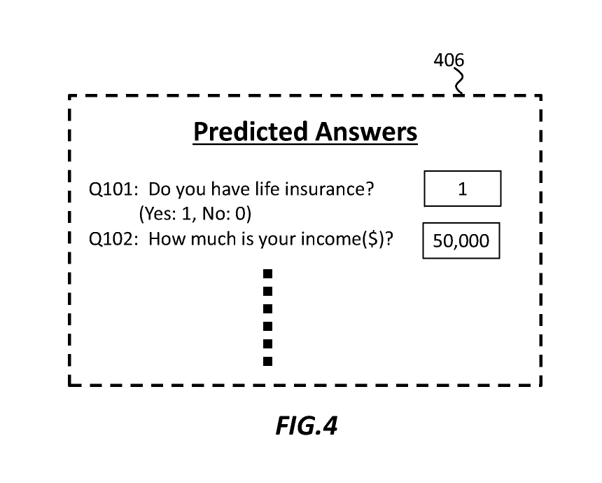

FIG. 4 shows predicted values 406, according to an embodiment. A predicting section, such as the predicting section 160, may predict, based on the prediction model, answers to questions that correspond to the remaining variables, as shown in FIG. 4. In this embodiment, the predicting section has predicted a value “1” of a remaining variable V₁₀₁ as an answer to Q101, and a value “50,000” of a remaining variable V₁₀₂ as an answer to Q102.

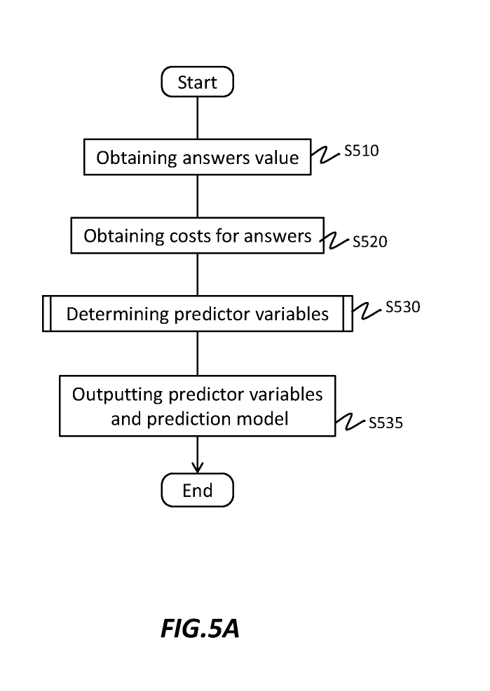

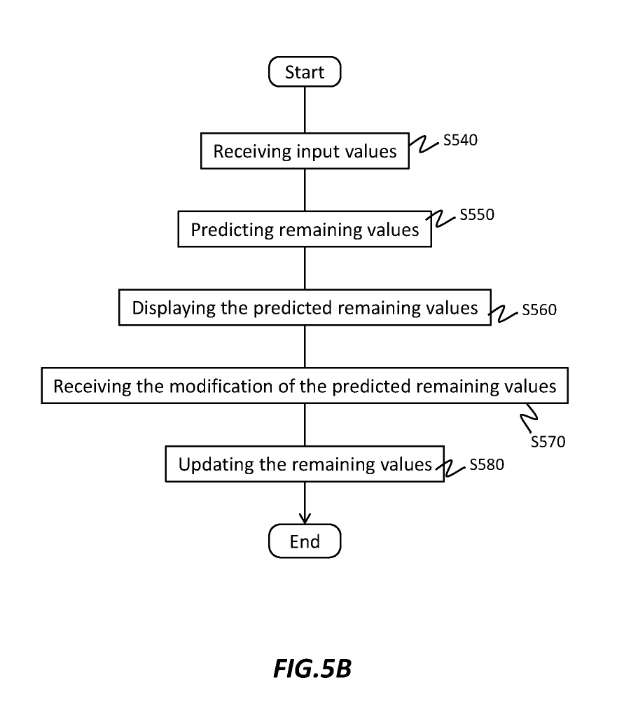

FIG. 5A shows an operational flow of an exemplary configuration of an apparatus in a modeling phase, according to an embodiment. This phase is usually executed offline before the apparatus is operated for customers. The present embodiment describes an example in which an apparatus, such as the apparatus 100, performs the operations from blocks S510 to S535 shown in FIG. 5A. FIG. 5A shows one example of the operational flow of the apparatus 100 shown in FIG. 1, but the apparatus 100 shown in FIG. 1 is not limited to using this operational flows explained below. Also, the operational flow in FIG. 5A may be performed by other embodiments of the apparatus.

First, a value obtaining section, such as the value obtaining section 110, may obtain a plurality of answers to questions from an answer database, as shown in block S510. Each answer corresponds to values of the plurality of variables. The answers are used as training and testing data for generating and evaluating a prediction model in the apparatus. The training data may be used for generating the prediction model and the testing data may be used for evaluating the generated prediction model. Each answer may include values of all or a portion of the plurality of variables. The value obtaining section may provide the determining section with the obtained plurality of answers as the training and/or testing data.

Next, a cost obtaining section, such as the cost obtaining section 120, may obtain a cost for answering each of the plurality of variables from a cost database, as shown in block S520. In some embodiments, each cost is a length of time taken by one of the plurality of respondents to answer one of the plurality of variables. In other embodiments, the cost obtaining section may obtain the cost for answering each of the plurality of variables by using an inverse of a response rate of the answered value for each of the plurality of variables. For example, if a response rate of a question corresponding to a first variable (V₁) is, e.g., 50%, then the cost obtaining section may obtain, e.g., 2=1/0.5 of the cost of the first variable (V₁). The cost obtaining section may provide the determining section with the obtained costs.

In some embodiments, the cost obtaining section may obtain the cost for answering each of the plurality of variables based on a relationship between the plurality of variables (e.g., a relationship of questions). For example, if a first question (e.g., corresponding to V₁) having an answering cost of, e.g., 1.0 is irrelevant to a second question (e.g., corresponding to V₂) having an answering cost of, e.g., 1.0, then the cost obtaining section may obtain costs for the variables V₁ and V₂ of 2.0 (1.0+1.0). On the other hand, if the first question (e.g., a question about an income) is relevant to the second question (e.g., a question about an income tax), then the cost obtaining section may obtain costs for the variables V₁ and V₂ of less than 2.0 (e.g., 1.5), because the burden of answering related questions may be less than that of answering irrelevant questions. In one embodiment, the cost obtaining section may calculate costs of a plurality of variables by multiplying the sum of each cost of the plurality of variables with a degree of relevance of the plurality of variables.

Next, a determining section, such as the determining section 130, may determine one or more predictor variables that are used in a prediction model from the plurality of variables based on a prediction accuracy and an answering cost of the prediction model, as shown in block S530. In other words, the determining section may determine questions that need to be filled in the answer sheet by respondents by determining the predictor variables. In some embodiments, the determining section may select predictor variables Xₘ to optimize an objective function s(X), based on formula (1) below:

Xₘ=argmax s(X) formula (1)
wherein V={V₁, V₂, . . . , V_{N}},
   X⊂V (X is a proper subset of the subset V), and
   Y=V−X,

s(X)=C_{V}−(C_{X}+(1−pf)*C_{Y})=pf*C_{Y} formula (2)

Here, C_{V} is a total cost (e.g., a sum of costs) of all variables included in the subset V, C_{X} is a total cost of all variables included in subset X, C_{Y} is a total cost of all variables included in subset Y, pf is an prediction accuracy of the prediction model based on the predictor variable(s) in the subset X. The determining section may use other constraints, such as a restriction of total costs.

The determining section may determine the predictor variable(s) based on various algorithms, such as (i) a greedy algorithm, (ii) a decision tree learning algorithm with recursive optimization of variable selection, (iii) a simulated annealing, (iv) a genetic algorithm, or (v) a step wise algorithm. The algorithms (i) and (ii) are described below in detail. Alternatively, the determining section may determine the predictor variables by (vi) other known methods to optimize an objective function that represents both the cost of the predictor variable candidate(s) and performance of the prediction model with the predictor variable candidate(s). The determining section also generates an optimized prediction model with the determined predictor variable(s), and provides the predicting section with the optimized prediction model.

Next, the determining section may output the predictor variable(s) and the optimized prediction model to the predicting section, as illustrated in block S535.

FIG. 5B shows an operational flow of an exemplary configuration of an apparatus in a prediction phase, according to an embodiment. This phase is usually executed online during their business operation with customer

In block S540, a receiving section, such as the receiving section 150, may receive an input value of the predictor variable(s) of the optimized prediction model. In other words, the receiving section may receive answers to a portion of the questions that corresponds to the predictor variable(s). The receiving section may obtain the input value(s) from the answer sheet, such as shown in FIG. 2, via the terminal device 106. The receiving section may provide the predicting section with the input value(s).

Next, a predicting section, such as the predicting section 160, may predict a value of the remaining variable(s) by using the optimized prediction model, as shown in block S550. In some embodiments, the predicting section may receive the input value(s) of the predictor variable(s) from the receiving section. Then, the predicting section may predict values of the remaining variables by using the optimized prediction model based on the input value(s) of the predictor variable(s). Then, the predicting section may provide the filling section with the predicted value(s). In other words, the predicting section may predict answer(s) that have not been answered by the respondents, and provide the filling section with the predicted answer(s).

Then, a filling section, such as the filling section 170, may fill in the value(s) of the remaining variable(s) predicted by the predicting section in the answer sheet. The filling section may provide the output section with the filled answer sheet.

Next, an output section, such as the output section 180, may output the filled answer sheet that has both input values of the predictor variable(s) and the filled value(s), as illustrated in block S560. In other words, the output section may output original answer(s) of a portion of question(s), and the predicted answer(s) of the remaining question(s). In some embodiments, the output section may display the filled answer sheet on a screen, such as an LCD, a projection screen, and/or an OLED of the apparatus and/or the terminal device.

Next, the receiving section may receive an input value of the remaining variable(s), as shown in block S570. In other words, the receiving section may receive additional answer(s) to question(s) to which answer(s) have already been predicted by the predicting section, and have been output by the output section. Thereby, the receiving section can receive modified answer(s) to question(s) from a respondent, if the respondent thinks that the predicted answer of the question is not correct.

Next, in block S580, the receiving section may further update the remaining variable(s) with the input value of the remaining variable(s) received by the receiving section in block S570. In other words, the receiving section may update the answer sheet with the modified answer(s) input by the respondent. The receiving section 150 may provide the output section 180 with the updated input value(s).

As described above, the apparatus according to the embodiments of FIG. 5A can determine predictor variables from the plurality of variables corresponding to questions based on the prediction performance and the answering cost. Thereby, the apparatus is able to provide only a portion of the questions and predict accurate answers to the other questions, while reducing the burden of answering questions in the embodiment of FIG. 5B. The apparatus may optimize a balance between the performance of the prediction and the cost incurred by the respondents. In other words, the apparatus can identify variables (questions) that need to be input by the respondents.

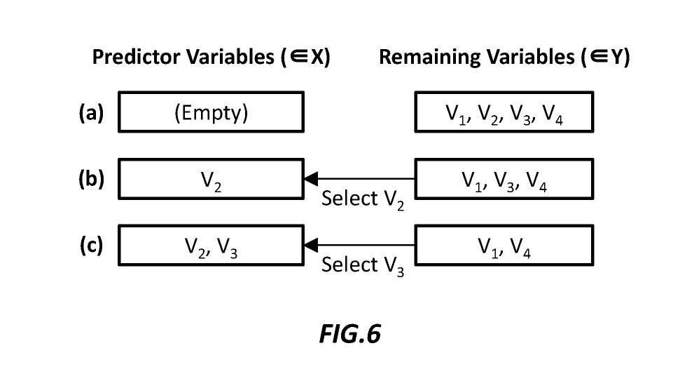

FIG. 6 shows an example of a greedy algorithm, according to an embodiment. In one embodiment, the determining section may determine predictor variables to be used in the optimized prediction model, by selecting predictor variables one-by-one, as shown in FIG. 6.

At first, no predictor variable is selected, and remaining variables include all of the variables V₁, V₂, V₃, and V₄ (as shown in (a)). Then, the determining section may select one predictor variable to optimize (e.g., maximize or minimize) an objective function. In this example, the objective function may be a function of an average prediction accuracy of the value of the at least one remaining variable candidate and the answering cost. In some embodiments, the determining section may select a new predictor variable xₙ to optimize an objective function s(X), based on formula (1)′ below:

xₙ=argmax_{xc} s(X) formula (1)′
wherein V={V₁, V₂, . . . , V_{N}},
   X⊂V (X is a proper subset of the subset V),
   x_{c}εV−Xₑ
   X={x_{c}}∪Xₑ (Xₑ is a set of current predictor variable(s)),
   Y=V−X,

s(X)=C_{V}−(C_{X}+(1−pf)*C_{Y})=pf*C_{Y} formula (2)

Here, C_{V} is a total cost (e.g., a sum of costs) of all variable(s) included in subset V, C_{X} is a total cost of all variable(s) included in subset X, C_{Y} is a total cost of all variable(s) included in subset Y, pf is an prediction accuracy of the prediction model based on the predictor variable(s) in the subset X. The prediction accuracy may be an average accuracy, which may be an average of a percentage of answers that are predicted correctly or that are predicted within a certain distance from the correct answers for the remaining variables. In the embodiment of FIG. 6, the determining section selects a variable V₂ as a new predictor variable xₙ as shown in (b) since an output of s({V₂}) is calculated to be the largest among those of s({V₁}), s({V₂}), s({V₃}) and s({V₄}).

Then, the determining section may further select one predictor variable xₙ, again from the remaining variables based on formula (1)′. At (c) in the embodiment of FIG. 6, Xₑ includes a variable V₂ and the determining section further selects a variable V₃ from the remaining V₁, V₃, and V₄ as a new predictor variable x_{n′}, since an output of s({V₂, V₃}) is calculated to be the largest among s({V₁, V₂}), s({V₂, V₃}), and s({V₂, V₄}). Here, the determining section may not select any predictor variable at (c) if an output of the objective function (e.g., s({V₂, V₃})) does not increase from the output of the objective function (e.g., s({V₂})) used at (b).

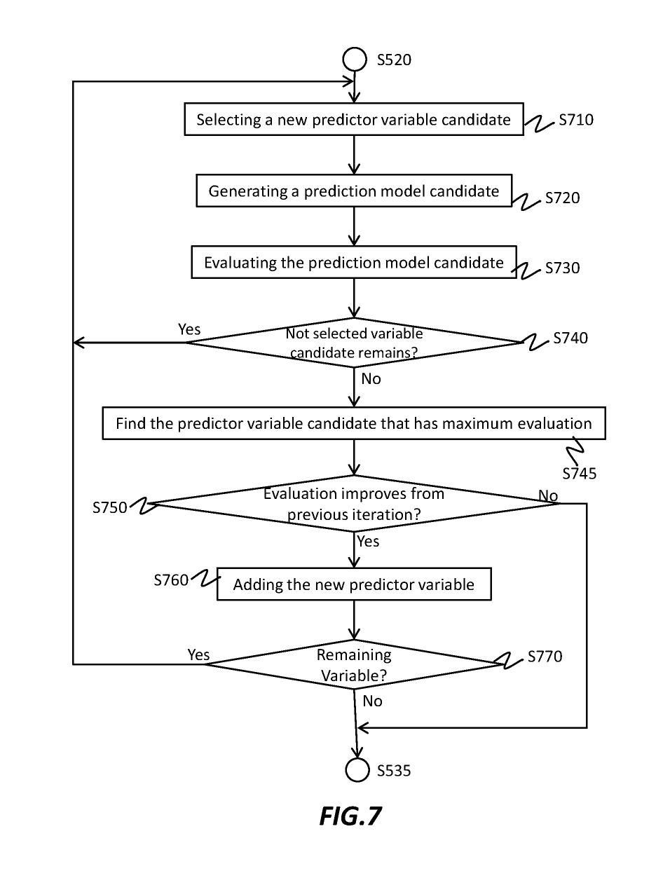

FIG. 7 shows an operational flow of a determination of predictor variables, according to an embodiment. In this embodiment, the determining section determines predictor variable(s) based on the greedy algorithm, such as explained by FIG. 6. The present embodiment describes an example in which an apparatus, such as the apparatus 100, performs a determination of predictor variables, such as in block S530 in FIG. 5A, by the operations from blocks S710 to S770 shown in FIG. 7.

First, the generating section, such as the generating section 132, may select a new predictor variable candidate, as illustrated in block S710. The generating section may select the predictor variable candidate from variables that have not been determined as the at least one predictor variable. For example, the generating section may select one of V₁, V₂, V₃, and V₄ at (a) of FIG. 6. The generating section may select one of V₁, V₃, and V₄, but may not select V₂ after (b) of FIG. 6 because V₂ has already been selected as the predictor variable. The generating section may select a predictor variable candidate that has not been selected as the predictor variable candidate in a loop of blocks S710-S740. For example, in the second loop of blocks S710-S740, if V₂ was already selected as the predictor variable candidate during the first loop, then the generating section does not select V₂, and selects one of the other variables.

Next, the generating section may generate a prediction model as a prediction model candidate for the predictor variable candidate, as illustrated in block S720. The generating section may generate the prediction model candidate by a known method, such as a decision tree, a regression tree, a linear regression, other multi-variate regression methods, etc. The generating section may generate a prediction model that estimates a probability distribution by maximum likelihood estimation and the like, and then predicts the remaining variable(s) based on the predictor variable(s) and the predictor variable candidate. With reference to FIG. 6, in an embodiment, if V₁ has already been selected as the predictor variable and V₂ is now selected as the predictor variable candidate, then the generating section may generate the prediction model that predicts values of V₁ and V₄ based on the value of V₂ and V₃. The generating section may provide the predicting section with the prediction model candidate and the testing data including the answered values.

Referring again to FIG. 7, the evaluating section, such as the evaluation section 134, may evaluate the prediction model candidate of the predictor variable candidate in block S730. In some embodiments, the predicting section may predict values of the remaining variables, based on (a) the prediction model candidate and (b) answered values of the predictor variable candidate (and values of the predictor variable(s), if any) of the testing data. Then, the predicting section may provide the evaluating section with the predicted values of the remaining variables. Then the evaluating section may calculate an output of the objective function by using the predicted values of the remaining variables, and determine the output as the evaluation of the predictor variable candidate.

In some embodiments, the evaluating section may determine an output of a function s(X) of formula (2) (wherein X includes both the predictor variable(s) and the predictor variable candidate), as the evaluation of the predictor variable candidate. For calculating the output of the function s(X), the evaluating section may calculate the prediction performance (e.g., prediction accuracy) of the remaining variable based on comparing a value of the at least one remaining variable predicted by the predicting section with at least one of the answered values corresponding to the remaining variable in the testing data from the answer database.

Instead of or in addition to the formula (2), the evaluating section may use an objective function as shown in a formula (3).

s(X)=C_{V}−(C_{X}+Σᵢ^{Y}(1−pᵢ)*C_{Yi}) formula (3)

Here, i is an index of a remaining variable subset Y, pᵢ is an accuracy of the i^{th} remaining variable in the subset Y, C_{Yi} is a cost of the i^{th} remaining variable in the subset Y, and Σᵢ^{Y} Aᵢ is an operator to output a sum of Aᵢ for variables in the subset Y.

The evaluating section may use an entropy gain, and/or, a Gini coefficient gain for discrete variables, and may be a mean squared error (MSE), and/or determination coefficient for contentious variables as prediction performance measures, instead of the prediction accuracy. Further, instead of or in addition to the formula (2) and (3), the evaluating section may use an objective function as shown in formula (4).

s(X)=a*ΔS/|Y|+(1−a)Cx formula (4)

Here, ΔS is an entropy gain, “a” is a constant that define a weight between a prediction performance and a cost, and |Y| is the number of the remaining variables.

Next, in block S740, the determining section, such as the determining section 130, may determine whether there remains a variable that has not been selected as a predictor variable candidate. For example, in the embodiment of (b) of FIG. 6, where only V₂ is selected as a predictor variable, the selecting section may determine whether V₁, V₃, and V₄ have been previously selected as predictor variable candidates. Thereby, the selecting section may determine whether the evaluations of the prediction model based on the predictor variables V₂ and V₁, the prediction model based on the predictor variables V₂ and V₃, and the prediction model based on the predictor variables V₂ and V₄ have been completed. If the decision is positive, then the selecting section may go back to block S710 of FIG. 7 to start a new loop of blocks S710-S740 to select a new variable as a predictor variable candidate. If the decision is negative, then the selecting section may proceed to block S745.

In block S745, the determining section may find the best predictor variable candidate that has maximum evaluation. In one embodiment, the selecting section, such as the selecting section 136, may find one predictor variable, of which a prediction model candidate has the maximum evaluation, from the predictor variable candidates selected at iterations of block S710.

At block S750, the determining section may determine whether the evaluation has improved from the previous iteration of the loop of blocks S710-S740. In one embodiment, the selecting section, such as the selecting section 136, may compare the evaluation of the prediction model candidate of the best predictor variable found at block S745, with the evaluation of the current prediction model. If the evaluation of the prediction model candidate of the best predictor variable candidate is larger than the evaluation of the current prediction model, then the selecting section may determine that the evaluation has improved.

For example, in the embodiment of (b) of FIG. 6, where only V₂ is selected as a predictor variable, the selecting section selects the best prediction model candidate based on the predictor variables V₂ and V₃ among the three prediction model candidates. Then, the selecting section compares the evaluation of the prediction model candidate based on the predictor variable V₂ and V₃ with the evaluation of the current prediction model based on the predictor variable V₂. In response to determining that the evaluation of the predictor variable V₂ and V₃ is larger than the evaluation of the predictor variable V₂, the selecting section determines that the evaluation has improved. If the decision is positive, then the selecting section may proceed to block S760. If the decision is negative, then the selecting section may end the process.

In block S760, the selecting section may add the new predictor variable based on the decision of block S750. In one embodiment, the selecting section may add a predictor variable candidate used in the prediction model candidate that improves the evaluation the most, as the new predictor variable. For example, in the embodiment of (b) of FIG. 6, where only V₂ is selected as a predictor variable in Xₑ, the selecting section selects V₃ as a new predictor variable xₙ, in response to determining that the evaluation of the predictor variable V₂ and V₃ is larger than the evaluation of the predictor variable V₂ in block S750.

Next, the selecting selection may determine whether there is a variable that has not been selected as the predictor variable, as shown in block S770. For example, in the embodiment of (c) of FIG. 6, where V₂ and V₃ are selected as predictor variables in Xₑ, the selecting section may determine that V₁ and V₄ have not been selected as predictor variables. Therefore, the selecting section may determine whether an additional predictor variable needs to be considered. If the decision is positive, then the selecting section may go back to block S710 to start to a new loop of block S710-S770 to select a new variable as a predictor variable. If the decision is negative, then the selecting section may end the process.

With blocks S710-S770, the determining section generates the optimized prediction model. In some embodiments, the determining section determines, at the end of the method of blocks S710-S770, a prediction model that includes all predictor variables that have been added in block S760 as the optimized prediction model. As explained in association with FIG. 7, during the loop of blocks S710-S740, the generating section may generate a prediction model for each of the plurality of variables that has not been determined as the at least one predictor variable, the evaluating section may evaluate each of the plurality of variables that has not been determined as the at least one predictor variable, and the selecting section may select one of the plurality of variables that has not been determined as the at least one predictor variable that improves the objective function the most to include in the at least one predictor variable.

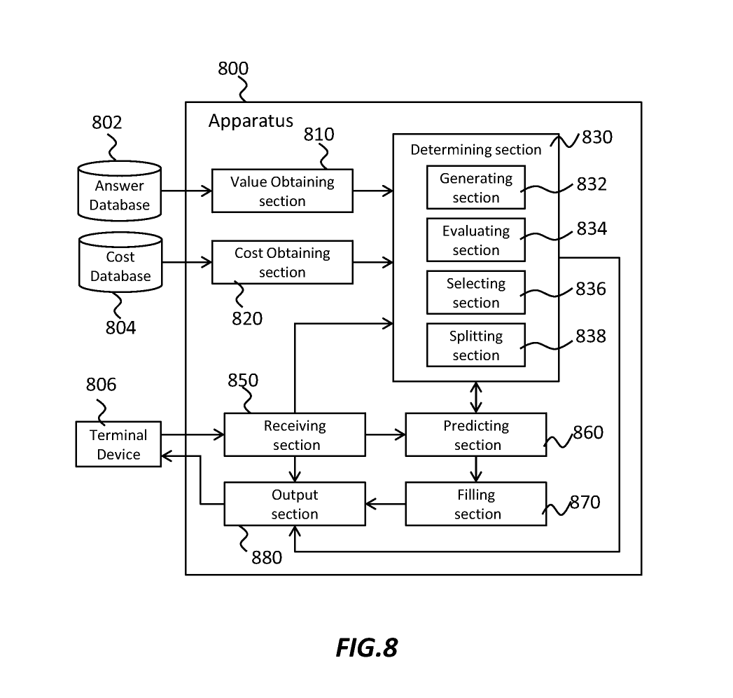

FIG. 8 shows an exemplary configuration of an apparatus 800, according to an embodiment of the present invention. The apparatus 800 may be suitable for determining predictor variable(s), based on a decision tree learning algorithm. In this embodiment, the apparatus 800 may perform the decision tree learning algorithm while recursively optimizing selection of predictor variables. Hereinafter, the algorithm may be referred to as “the decision tree learning algorithm with recursive optimization of variable selection.” The apparatus 800 may include a value obtaining section 810, a cost obtaining section 820, a determining section 830, a receiving section 850, a predicting section 860, a filling section 870, and an output section 880.

Each element in the embodiment of FIG. 8 may correspond to an element of the apparatus 100 in FIG. 1. For example, the answer database 802 may correspond to the answer database 102, the cost database 804 may correspond to the cost database 104, the terminal device 806 may correspond to the terminal device 106, the value obtaining section 810 may correspond to the value obtaining section 110, the cost obtaining section 820 may correspond to the cost obtaining section 120, the determining section 830 may correspond to the determining section 130, the receiving section 850 may correspond to the receiving section 150, the predicting section 860 may correspond to the predicting section 160, the filling section 870 may correspond to the filling section 170, and the output section 880 may correspond to the output section 180. The description of corresponding elements remains the same as in FIG. 1, unless otherwise indicated.

In this embodiment, the determining section 830 may include a splitting section 838, a generating section 832, an evaluating section 834, and a selecting section 836. The splitting section 838 may split a domain of one of the plurality of variables selected by the selecting section in a decision tree used in the decision tree learning algorithm with recursive optimization of variable selection. In this embodiment, the receiving section 850 may further be connected to the determining section 830 and provide the determining section 830 with the input data.

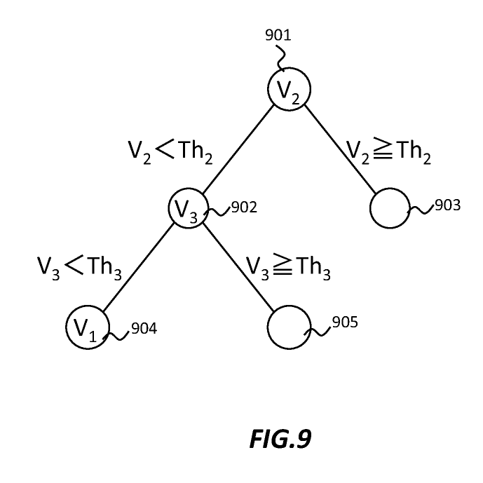

FIG. 9 shows an example of a decision tree learning algorithm with recursive optimization of variable selection, according to an embodiment of the present invention. In some embodiments, the apparatus 800 may generate and optimize a prediction model in an integrated manner. In these embodiments, the generating section 832, the evaluating section 834, the selecting section 836, and the splitting section 838 may hierarchically select at least one predictor variable to generate a decision tree of the at least one predictor variable. A tree structure, as illustrated in FIG. 9, includes a node 901, a node 902, a node 903, a node 904, and a node 905, each of which represents a selection of the predictor variable. In an embodiment of FIG. 9, the apparatus 800 has received the answered values of four (4) variables (V₁, V₂, V₃, and V₄) corresponding to four (4) questions.

In some embodiments, the selecting section 836 may first select one variable (V₂) from the plurality of variables as a first predictor variable at the node 902 to optimize an output of the objective function s(X). The selecting section 836 may select the single variable in the same manner as selecting a new predictor variable of FIG. 6.

Then, the splitting section 838 may split a domain of a new predictor variable (V₂). In the embodiment of FIG. 9, the splitting section 838 splits the domain of V₂ into a first range (V₂<Th₂: Th₂ indicates a threshold value for the variable V₂) and a second range (V₂>=Th₂), thereby allocating new nodes 902 and 903 to these ranges. The first range (V₂<Th₂) is allocated to node 902, and the second (V₂>=Th₂) is allocated to node 903. The splitting section 838 may select a node of one of the first range and the second range. In the embodiment of FIG. 9, the splitting section 838 first selects the node 902.

Then, the selecting section 836 may select another variable as a new predictor variable at the selected node. In the embodiment of FIG. 9, the selecting section 836 may select a new variable V₃ from the remaining variables (V₁, V₃, V₄) as a second predictor variable at the selected node 902 to optimize an output of the objective function s(X) depending on the selected range (the first range V₂<Th₂). For example, the selecting section may generate the prediction model candidates of the predictor variable candidates based on the answered values that are within the first range (V₂<Th₂), calculate outputs of the prediction model candidates, select the best prediction model candidate, including a predictor variable candidate V₃, as the optimized prediction model, and determine a variable V₃ as a new predictor variable candidate, at the node 902.

Then, the splitting section 838 may further split a domain of a new predictor variable V₃ into a first range (V₃<Th₃) and a second range (V₃>=Th₃). The selecting section 836 may further select a new predictor variable (e.g., V₁) for the selected range (e.g., V₃<Th₃:Th₃ indicates a threshold value for the variable V₃) at the node 904, in the same manner as the node 902.

The selecting section 836 may stop selecting predictor variables if the objective function does not improve during evaluation by the evaluating section 834. In the embodiment of FIG. 9, the selecting section 836 may stop selecting a further predictor variable if the objective function of the prediction model candidate that has predictor variables (V₂, V₃ and V₁) and any predictor variable candidate (e.g., V₄) does not improve the output of the objective function of the current prediction model that has predictor variables (V₂, V₃ and V₁). Then, the selecting section 836 may proceed with selection of the predictor variable for remaining nodes, such as node 905 or node 903.

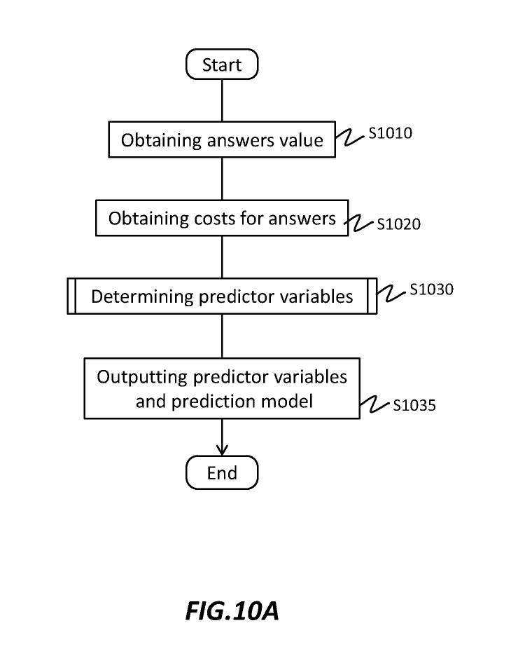

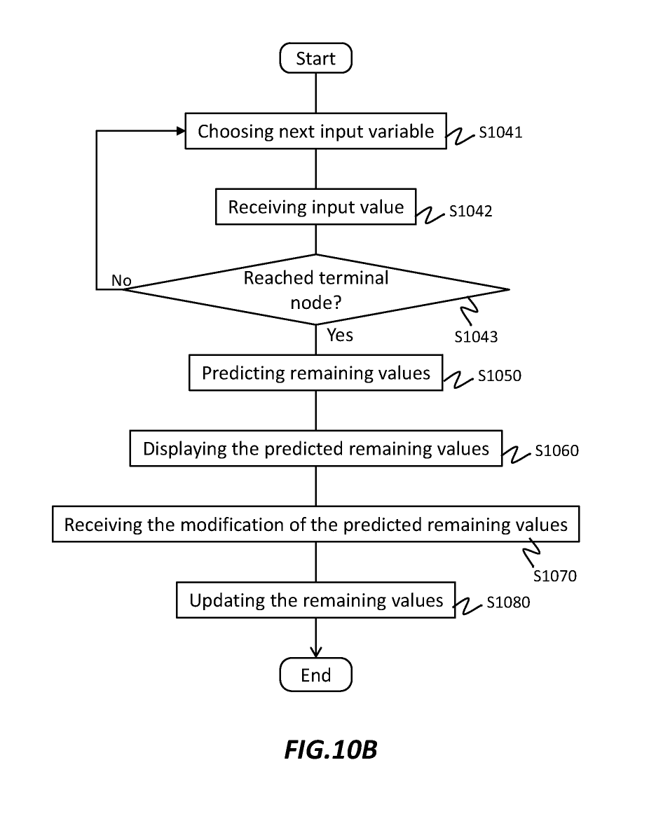

FIG. 10A shows an operational flow of an exemplary configuration of an apparatus in a modeling phase, according to an embodiment of the present invention. An apparatus, such as apparatus 800, may perform a method explained by FIG. 9 of this operational flow. The present embodiment describes an example in which the apparatus performs the operations from blocks S1010 to S1035 shown in FIG. 10A. FIG. 10A shows one example of the operational flow of the apparatus 800 shown in FIG. 8, but the apparatus 800 shown in FIG. 8 is not limited to using this operational flows explained below. Also, the operational flow in FIG. 10A may be performed by other embodiments.

Some of the steps in the embodiment of FIG. 10A may correspond to some of the blocks illustrated in FIG. 5A. In some embodiments, block S1010 may be performed in the same manner as block S510, block S1020 may be performed in the same manner as block S520, and block S1035 may be performed in the same manner as block S535.

A process corresponding to block S530 is performed in block S1030 in this embodiment. In this embodiment, the determining section may determine the predictor variables while receiving an input value from a respondent via the receiving section in block S1030.

Now referring to FIG. 10B, the apparatus, such as the apparatus 800 in FIG. 8, may perform the operational flow of FIG. 10B after performing the flow of FIG. 10A. This flow is similar to FIG. 5B and corresponds to the prediction phase. The apparatus may predict values of the remaining variables based on the prediction model generated by the flow of FIG. 10A. In block S1041, a variable to be asked to a user is selected. For the first iteration, the root variable (e.g., V₂ in FIG. 9) is selected. In later iterations, one of the variables associated with the child nodes of the root variable (e.g., Node 902 or 903 in FIG. 9) is selected, depending on a comparison result of the value of the variable input by the user in block S1042 and ranges of the current node. This process is recursively iterated until one of the terminal nodes is reached, as illustrated in block S1043. Then, the remaining variables are predicted from the values inputted by user in the above steps, as shown in block S1050. The apparatus may perform blocks S1060-S1080 similarly to blocks S560-S580 in the embodiment described in FIG. 5B.

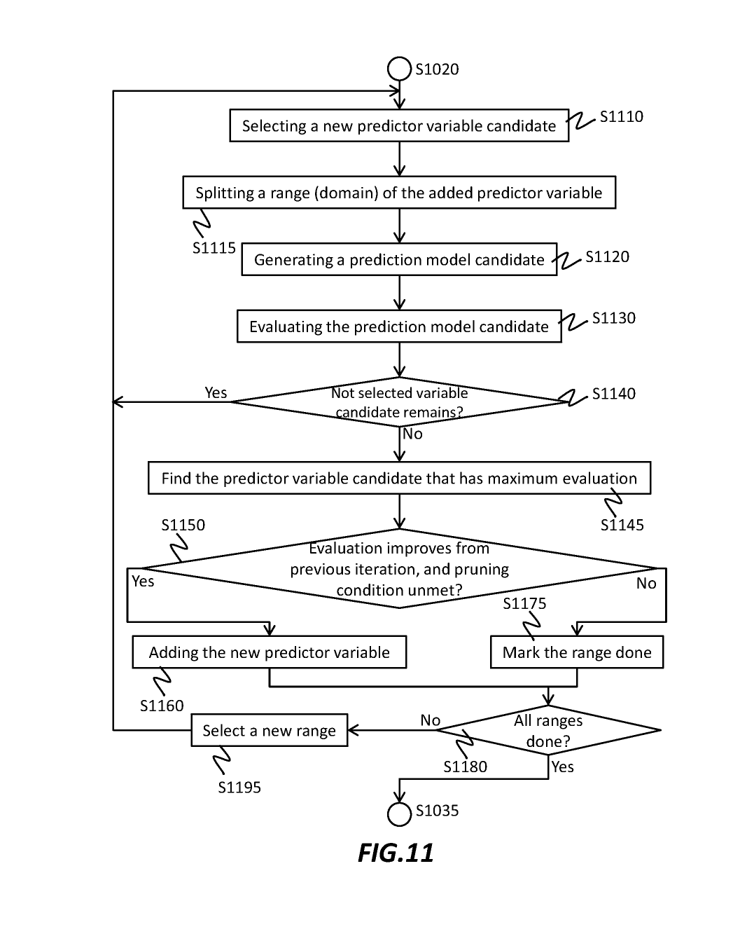

FIG. 11 shows an operational flow of the determination of a predictor variable, according to an embodiment of the present invention. The present embodiment describes an example in which an apparatus, such as the apparatus 800, performs block S1030 by the operations from blocks S1110 to S1195 shown in FIG. 11.

Some of the blocks in the embodiment of FIG. 11 may correspond to some of the blocks of FIG. 7. In some embodiments, block S1110 may be performed in the same manner as block S710, block S1120 may be performed in the same manner as block S720, block S1130 may be performed in the same manner as block S730, block S1140 may be performed in the same manner as block S740, block S1145 may be performed in the same manner as block S745, and block S1160 may be performed in the same manner as block S760.

First, the generating section, such as the generating section 832, may select a new predictor variable candidate in block S1110. The generating section may select the predictor variable candidate from variables that have not been determined as the at least one predictor variable. For example, the generating section may select one of V₁, V₂, V₃, and V₄ in the embodiment of FIG. 9. The generating section may select one of V₁, V₂, V₃, and V₄, at node 901. The generating section may select one of V₁, V₃, and V₄, but may not select V₂ at node 902 of FIG. 9 because V₂ has been already selected as the predictor variable at parent node 901. The generating section may select a predictor variable candidate that has not been selected as the predictor variable candidate in a loop of blocks S1110-S1140. For example, in the second loop of blocks S1110-S1140, if V₂ was already selected as the predictor variable candidate at the first loop, then the generating section does not select V₂ and selects one of the other variables.

Referring back to FIG. 11, at block S1115, the splitting section, such as the splitting section 838, may split a domain of a predictor variable candidate selected at the most recent S1110. The splitting section may split the domain by a method usually utilized for the generation of a decision tree, such as entropy gain maximization. The splitting section may split the domain of the predictor variable candidate into a plurality of ranges (e.g., the first range (V₂<Th₂) and the second range (V₂>=Th₂) for a predictor variable candidate V₂ at a node 901 in FIG. 9). The splitting section may split the domain by a method usually used for construction of a decision/regression tree and predictions of the remaining variables are assigned to the both ranges. For example, the splitting section may split the domain of the new predictor variable candidate to maximize the entropy gain of the remaining variables. In this embodiment, the splitting section may determine threshold(s) of the selected predictor variable candidate, such that predicted value(s) of the remaining variable(s) based value(s) of the predictor variable candidate under the threshold is separated the most from value(s) of the remaining variable(s) based value(s) of the predictor variable candidate above the threshold.

In block S1120, the generating section may generate a prediction model as a prediction model candidate for the predictor variable candidate. The generating section may generate the prediction model candidate by the decision tree, which is generated as a result of block S1115. Predicted values are assigned to all the terminal (leaf) nodes of the tree. In the embodiment of FIG. 9, if V₂ has already been selected as the predictor variable and V₁ is now selected as the predictor variable candidate, then the generating section may generate the prediction model that predicts values of V₃ and V₄ based on the value of V₂ and V₁. The generating section may provide the predicting section with the prediction model candidate, and the testing data including the answered values.

Referring back to FIG. 11, the evaluating section, such as the evaluating section 834, may evaluate the predictor variable candidate selected at the most recent S1110, as shown in block S1130. In some embodiments, the predicting section may predict values of the remaining variables, based on (a) the prediction model candidate generated at the most recent S1120 and (b) values of the predictor variable candidate (and values of the predictor variable(s) if any). Then, the predicting section may provide the evaluating section with the predicted values of the remaining variables. Then, the evaluating section may calculate an output of the objective function by using the predicted values of the remaining variables, and determine the output as the evaluation of the predictor variable candidate.

In one embodiment, the evaluating section may determine an output of a function s(X) of formula (2) (wherein X includes both the predictor variable(s) and the predictor variable candidate), as the evaluation of the predictor variable candidate. The evaluating section may calculate the prediction performance (e.g., the prediction accuracy) of the remaining variable based on comparing a value of the at least one remaining variable predicted by the predicting section with at least one of the answered values corresponding to the remaining variable in the testing data from the answer database. Instead of or in addition to formula (2), the evaluating section may use an objective function as shown in formula (3) and/or formula (4).

Next, the selecting section, such as the selecting section 836, may determine whether there remains a variable that has not been selected as a predictor variable candidate at S1110, as shown in block S1140. For example, at the node 902 in the embodiment of FIG. 9, where only V₂ is selected as a predictor variable, the selecting section may determine whether V₁, V₃, and V₄ has been each selected as a predictor variable candidate. Thereby, the selecting section may determine whether the evaluations of the prediction model based on the predictor variables V₂ and V₁, the prediction model based on the predictor variables V₂ and V₃, and the prediction model based on the predictor variables V₂ and V₄ have been completed. If the decision is positive, then the selecting section may go back to block S1110 to start a new loop of blocks S1110-S1140 to select a new variable as a predictor variable candidate. If the decision is negative, then the selecting section may proceed to block S1145.

At block S1145, the determining section may find the best predictor variable candidate that has maximum evaluation. In one embodiment, the selecting section, such as the selecting section 836, may find one predictor variable, of which a prediction model candidate has the maximum evaluation, from the predictor variable candidates selected at iterations in block S1110.

Next, in block S1150, the determining section may determine whether the evaluation improves from the previous iteration of the loop of blocks S1110-S1140 and whether a pruning condition is unmet. In some embodiments, the selecting section, such as the selecting section 836, may compare the evaluation of the prediction model candidate of the best predictor variable found at block S1145 with the evaluation of the current prediction model. If the evaluation of the prediction model candidate of the best predictor variable candidate is larger than the evaluation of the current prediction model, then the selecting section may determine that the evaluation has improved.

For example, at the node 902 in the embodiment of FIG. 9, where only V₂ is selected as a predictor variable, the selecting section selects the best prediction model candidate based on the predictor variable V₂ and V₃ among the three prediction model candidates. Then, the selecting section compares the evaluation of the prediction model candidate based on the predictor variable V₂ and V₃ with the evaluation of the current prediction model based on the predictor variable V₂. In response to determining that the evaluation of the predictor variable V₂ and V₃ is larger than the evaluation of the predictor variable V₂, the selecting section determines that the evaluation has improved.

In addition to the determining whether the evaluation has improved, the selecting section may further determine whether a pruning condition is not met. In one embodiment, the pruning condition is that a depth of a current decision tree exceeds the predefined maximum depth, that the number of the training samples is less than the predefined minimum, and/or, that all variables have been selected as the predictor variable.

If the decision of block S1150 is positive, then the selecting section may proceed to block S1160. If the decision is negative, then the selecting section may proceed to block S1175.

In block S1160, the selecting section may add a new predictor variable based on the decision of block S1150. In some embodiments, the selecting section may add a predictor variable candidate used in the prediction model candidate that improves the evaluation the most, as the new predictor variable. For example, at the node 902 in the embodiment of FIG. 9, where only V₂ is selected as a predictor variable, the selecting section selects V₃ as a new predictor variable, in response to determining that the evaluation of the predictor variable V₂ and V₃ is larger than the evaluation of the predictor variable V₂ at S1150 and that the pruning condition is not met. Then, the selecting section may proceed to block S1180.

In block S1175, the selecting section may mark the current range done. For example, at the node 902 in the embodiment of FIG. 9, where only V₂ has been selected as a predictor variable and now the decision of block S1150 is found to be negative, the selecting section marks the current range (V₂<Th₂) at the current node 902 as done, because a further search of the branches depending on the node 902 is worthless. Then the selecting section may proceed to block S1180.

In block S1180, the selecting section may determine whether all ranges have been marked done. If the decision is positive, then the selecting section may end the process. If the decision is negative, then the selecting section may proceed to block S1195.

Next, in block S1195, the selecting section may select a new range. In one embodiment, the selecting section may select a range that has not been selected. For example, at the node 904 in the embodiment of FIG. 9, where the range (V₂<Th₂) and the range (V₃<Th₃) have been selected, the selecting section may select a range (V₃>=Th₂) or a range (V₂>=Th₂). The selecting section may select a new range based on depth-first search or breadth-first search.

As explained in association with FIG. 11, during the loop of blocks S1110-S1140, the generating section may generate a prediction model for each of the plurality of variables that has not been determined as the at least one predictor variable, the evaluating section may evaluate each of the plurality of variables that has not been determined as the at least one predictor variable, and the selecting section may select one of the plurality of variables that has not been determined as the at least one predictor variable and that improves the objective function the most to include in the at least one predictor variable.

According to embodiments of FIGS. 9-11, the apparatus can provide a respondent with an appropriate prediction model based on answers of the respondent. For example, in the embodiment of FIG. 9, the apparatus may first provide a first question corresponding to the variable V₂. If the answered value v₂ is below Th₂, then the apparatus provides a second question corresponding to variable V₃. If the answered value v₃ is below Th₃, then the apparatus provides a third question corresponding to the variable V₁.

In the embodiments above, the variables that the apparatus handles may relate to questions and answers thereof, and the costs may relate to answering costs of the questions. However, the present invention is not limited to this application. For example, the variables may relate to parameters that are measured, counted, observed, or obtained with some costs, wherein the cost may represent financial, temporal, computational, physical, and/or psychological resources that need values obtained for each of the variables.

In the embodiments above, the variables are categorized into the predictor variable(s) and the remaining variable(s), where the predictor variable(s) may be input from the respondent, and may be used to predict the remaining variable(s) with the prediction model. However, in some embodiments, some variable(s) (referred to as “unused variable(s)”) may not be predicted by the predictor variables nor used for the prediction. In these embodiments, value(s) of the predictor variable(s) and value(s) of the unused variable(s) are input and only the value(s) of the predictor variable(s) may be used for the prediction of the remaining variable(s).

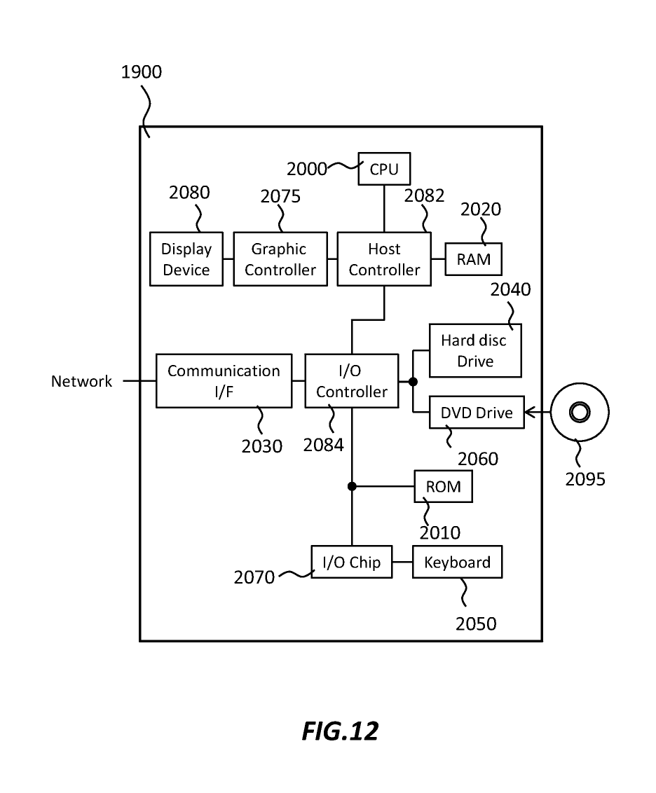

FIG. 12 shows an exemplary configuration of a computer system 1900 according to an embodiment. The computer 1900 according to the present embodiment includes a computer processing unit (CPU) 2000, a RAM 2020, a graphics controller 2075, and a display apparatus 2080, which are mutually connected by a host controller 2082. The computer 1900 also includes input/output units such as a communication interface 2030, a hard disk drive 2040, and a DVD-ROM drive 2060, which are connected to the host controller 2082 via an input/output controller 2084. The computer also includes legacy input/output units such as a ROM 2010 and a keyboard 2050, which are connected to the input/output controller 2084 through an input/output chip 2070.

The host controller 2082 connects the RAM 2020 with the CPU 2000 and the graphics controller 2075, which access the RAM 2020 at a high transfer rate. The CPU 2000 operates according to programs stored in the ROM 2010 and the RAM 2020, thereby controlling each unit. The graphics controller 2075 obtains image data generated by the CPU 2000 on a frame buffer or the like provided in the RAM 2020, and causes the image data to be displayed on the display apparatus 2080. Alternatively, the graphics controller 2075 may contain therein a frame buffer or the like for storing image data generated by the CPU 2000.

The input/output controller 2084 connects the host controller 2082 with the communication interface 2030, the hard disk drive 2040, and the DVD-ROM drive 2060, which are relatively high-speed input/output units. The communication interface 2030 communicates with other electronic devices via a network. The hard disk drive 2040 stores programs and data used by the CPU 2000 within the computer 1900. The DVD-ROM drive 2060 reads the programs or the data from the DVD-ROM 2095, and provides the hard disk drive 2040 with the programs or the data via the RAM 2020.

The ROM 2010 and the keyboard 2050 and the input/output chip 2070, which are relatively low-speed input/output units, are connected to the input/output controller 2084. The ROM 2010 stores therein a boot program or the like executed by the computer 1900 at the time of activation, a program depending on the hardware of the computer 1900. The keyboard 2050 inputs text data or commands from a user, and may provide the hard disk drive 2040 with the text data or the commands via the RAM 2020. The input/output chip 2070 connects a keyboard 2050 to an input/output controller 2084, and may connect various input/output units via a parallel port, a serial port, a keyboard port, a mouse port, and the like to the input/output controller 2084.

A program to be stored on the hard disk drive 2040 via the RAM 2020 is provided by a recording medium as the DVD-ROM 2095, and an IC card. The program is read from the recording medium, installed into the hard disk drive 2040 within the computer 1900 via the RAM 2020, and executed in the CPU 2000.

A program that is installed in the computer 1900 and causes the computer 1900 to function as an apparatus, such as the apparatus 100 of FIG. 1 and the apparatus 800 of FIG. 8. The program or module acts on the CPU 2000, to cause the computer 1900 to function as a section, component, element such as each element of the apparatus 100 of FIG. 1 (e.g., the value obtaining section 110, the determining section 130, the generating section 132, and the like) and each element of the apparatus 800 of FIG. 8.

The information processing described in these programs is read into the computer 1900, to function as the determining section, which is the result of cooperation between the program or module and the above-mentioned various types of hardware resources. Moreover, the apparatus is constituted by realizing the operation or processing of information in accordance with the usage of the computer 1900.

For example, when communication is performed between the computer 1900 and an external device, the CPU 2000 may execute a communication program loaded onto the RAM 2020, to instruct communication processing to a communication interface 2030, based on the processing described in the communication program.

The communication interface 2030, under control of the CPU 2000, reads the transmission data stored on the transmission buffering region provided in the recording medium, such as a RAM 2020, a hard disk drive 2040, or a DVD-ROM 2095, and transmits the read transmission data to a network, or writes reception data received from a network to a reception buffering region or the like provided on the recording medium. In this way, the communication interface 2030 may exchange transmission/reception data with the recording medium by a direct memory access (DMA) method, or by a configuration that the CPU 2000 reads the data from the recording medium or the communication interface 2030 of a transfer destination, to write the data into the communication interface 2030 or the recording medium of the transfer destination, so as to transfer the transmission/reception data.

In addition, the CPU 2000 may cause all or a necessary portion of the file of the database to be read into the RAM 2020 such as by DMA transfer, the file or the database having been stored in an external recording medium such as the hard disk drive 2040, the DVD-ROM drive 2060 (DVD-ROM 2095) to perform various types of processing onto the data on the RAM 2020. The CPU 2000 may then write back the processed data to the external recording medium by means of a DMA transfer method or the like. In such processing, the RAM 2020 can be considered to temporarily store the contents of the external recording medium, and so the RAM 2020, the external recording apparatus, and the like are collectively referred to as a memory, a storage section, a recording medium, a computer readable medium, etc.

Various types of information, such as various types of programs, data, tables, and databases, may be stored in the recording apparatus, to undergo information processing. Note that the CPU 2000 may also use a part of the RAM 2020 to perform reading/writing thereto on the cache memory. In such an embodiment, the cache is considered to be contained in the RAM 2020, the memory, and/or the recording medium unless noted otherwise, since the cache memory performs part of the function of the RAM 2020.

The CPU 2000 may perform various types of processing, onto the data read from the RAM 2020, which includes various types of operations, processing of information, condition judging, search/replace of information, etc., as described in the present embodiment and designated by an instruction sequence of programs, and writes the result back to the RAM 2020. For example, when performing condition judging, the CPU 2000 may judge whether each type of variable shown in the present embodiment is larger, smaller, no smaller than, no greater than, or equal to the other variable or constant, and when the condition judging results in the affirmative (or in the negative), the process branches to a different instruction sequence, or calls a sub routine.

In addition, the CPU 2000 may search for information in a file, a database, etc., in the recording medium. For example, when a plurality of entries, each having an attribute value of a first attribute is associated with an attribute value of a second attribute, are stored in a recording apparatus, the CPU 2000 may search for an entry matching the condition whose attribute value of the first attribute is designated, from among the plurality of entries stored in the recording medium, and reads the attribute value of the second attribute stored in the entry, thereby obtaining the attribute value of the second attribute associated with the first attribute satisfying the predetermined condition.

The above-explained program or module may be stored in an external recording medium. Exemplary recording mediums include a DVD-ROM 2095, as well as an optical recording medium such as a Blu-ray Disk or a CD, a magneto-optic recording medium such as a MO, a tape medium, and a semiconductor memory such as an IC card. In addition, a recording medium such as a hard disk or a RAM provided in a server system connected to a dedicated communication network or the Internet can be used as a recording medium, thereby providing the program to the computer 1900 via the network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server.

In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s).

In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiment(s) of the present invention has (have) been described, the technical scope of the invention is not limited to the above described embodiment(s). It is apparent to persons skilled in the art that various alterations and improvements can be added to the above-described embodiment(s). It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

As made clear from the above, the embodiments of the present invention can be used to realize the apparatus for the optimization of predictor variables.

1. An apparatus for optimization of predictor variables, comprising:
a value obtaining section to obtain a plurality of answers from an answer database, wherein each answer includes an answered value for each variable of a plurality of variables, the plurality of variables answered by each respondent of a plurality of respondents;
a cost obtaining section to obtain a cost for answering each of the plurality of variables from a cost database; and
a determining section to determine, using a processor, at least one predictor variable from the plurality of variables based on a prediction performance and an answering cost, the at least one predictor variable for predicting at least one remaining variable of the plurality of variables.

2. The apparatus of claim 1, wherein the determining section includes:
a generating section to generate a prediction model for predicting a value of at least one remaining variable candidate based on a given value of at least one predictor variable candidate;
an evaluating section to evaluate the at least one predictor variable candidate using an objective function, the objective function being a function of the prediction performance and the answering cost, wherein the prediction performance is derived from the prediction model; and
a selecting section to select the at least one predictor variable based on a result of evaluation of the evaluating section.

3. The apparatus of claim 2, wherein the prediction performance is a prediction accuracy, a Gini index, or an entropy gain of the prediction model.

4. The apparatus of claim 2, wherein the objective function is a function of an average prediction accuracy of the value of the at least one remaining variable candidate and the answering cost.

5. The apparatus of claim 2, further comprising:
a receiving section to receive an input value of the at least one predictor variable input in an answer sheet; and
a predicting section to predict a value of the at least one remaining variable by using the prediction model for predicting the value of the at least one remaining variable based on the input value of the at least one predictor variable.

6. The apparatus of claim 5, further comprising a filling section to fill in the value of the at least one remaining variable predicted by the predicting section in the answer sheet.

7. The apparatus of claim 5, wherein the receiving section is further configured to:
receive an input value of the at least one remaining variable; and
update the at least one remaining variable with the input value of the at least one remaining variable received by the receiving section.

8. The apparatus of claim 2, wherein:
the generating section is further configured to generate a prediction model for each of the plurality of variables that has not been determined as the at least one predictor variable;
the evaluating section is further configured to evaluate each of the plurality of variables that has not been determined as the at least one predictor variable; and
the selecting section is further configured to select one of the plurality of variables that has not been determined as the at least one predictor variable that improves the objective function to include in the at least one predictor variable.

9. The apparatus of claim 8, further comprising:
a splitting section to split a domain of the one of the plurality of variables selected by the selecting section;
wherein the generating section, the evaluating section, the selecting section, and the splitting section are further configured to hierarchically select the at least one predictor variable to generate a decision tree of the at least one predictor variable.

10. The apparatus of claim 2, wherein the selecting section is further configured to stop selecting predictor variables if the objective function does not improve during evaluation by the evaluating section.

11. The apparatus of claim 1, wherein each cost is a length of time taken by one of the plurality of respondents to answer one of the plurality of variables.

12. The apparatus of claim 1, wherein the cost obtaining section is further configured to obtain the cost for answering each of the plurality of variables by using a response rate of the answered value for each of the plurality of variables.

13. The apparatus of claim 3, wherein the prediction accuracy is based on comparing a value of the at least one remaining variable predicted by the predicting section with at least one of the answered values corresponding to the remaining variable in the answer database.

14. A computer-implemented method for optimization of predictor variables, comprising:
obtaining a plurality of answers from an answer database, wherein each answer includes an answered value for each variable of a plurality of variables, the plurality of variables answered by each respondent of a plurality of respondents;
obtaining a cost for answering each of the plurality of variables from a cost database; and
determining at least one predictor variable from the plurality of variables by a processor based on a prediction performance and an answering cost, the at least one predictor variable for predicting at least one remaining variable of the plurality of variables.

15. A computer program product comprising a non-transitory computer readable storage medium having program instructions embodied therewith, the program instructions executable by a computer to cause the computer to perform a method comprising:
obtaining a plurality of answers from an answer database, wherein each answer includes an answered value for each variable of a plurality of variables, the plurality of variables answered by each respondent of a plurality of respondents;
obtaining a cost for answering each of the plurality of variables from a cost database; and
determining at least one predictor variable from the plurality of variables based on a prediction performance and an answering cost, the at least one predictor variable for predicting at least one remaining variable of the plurality of variables.
